(19) United States
(12) Patent Application Publication
(10) Pub. No.: US 2006/0184433 A1
(43) Pub. Date: Aug. 17, 2006

(54) Method or application for generating postings based on transformation rules and posting classes

(75) Inventors: Hans Jorgen Gron, Slangerup (DK); Robert F. Blanch, Clyde Hill, WA (US); Srinivasan Parthasarathy, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, CA (US)

(21) Appl. No.: 11/056,384

(22) Filed: Feb. 11, 2005

(51) Int. Cl. G07F 19/00; G07B 17/00

(52) U.S. Cl. 705/30

(57) ABSTRACT

An application or method of populating a transaction from a document using procedures associated with document type. In the embodiments described, the application or method posts a financial transaction from a financial document, such as a sales invoice or vendor bill to a financial account, such as A/R or COGS. In embodiments described, the application or method employs posting procedures for posting types associated with the document type and document line type of the document. The posting procedures are invoked for the posting class or type attributed to the document type or the document line type to post the transaction.

### BACKGROUND OF THE INVENTION

The present invention relates to an application for populating business transaction information in a general ledger table or record table based on transformation rules.

In particular, the present invention has application for capturing financial details involved in a business transaction using a posting pipeline process based on meta data driven transformation rules.

Accounting applications or software can generate financial documents such a sales invoice, credit memo, vendor invoice and other documents, which include transactions for a particular customer, vendor or financial account. For accounting purposes, the transactions in these documents must be populated or posted to related financial accounts or a general ledger. For example, transactions or items in a sales invoice are generally posted in an income account, cost of goods and services (COGS) account and accounts receivable (A/R).

Postings can be implemented by a posting engine to generate account postings. However, different business rules in different countries can require different posting options and it can be difficult to adapt the posting engine. The present invention provides a solution for posting or populating transactions by isolating the transformation rules and making the posting process totally data driven, thereby increasing the adaptablity of the posting engine.

### SUMMARY OF THE INVENTION

The present invention relates to an application or method of populating a transaction from one document to another document using procedures associated with the transaction or document type. In the embodiments described, the application or method posts a financial transaction from a financial document, such as a sales invoice or vendor bill to a set of financial accounts, such as A/R or COGS. In embodiments described, the application or method employs posting procedures for posting types associated with the document type and document line type of the document.

Meta data on the document, document line types and posting classes determine what type of posting classes are invoked during the posting process and what postings are generated per document line for a document.

### BRIEF DESCRIPTION OF THE DRAWINGS

FIG. 1 is a block diagram of one illustrative embodiment of a computing environment in which the present invention can be used or implemented.

FIG. 2 is a block diagram of an embodiment of the present invention for posting transactions using posting procedures for posting types attributed to the document type.

FIG. 3 illustrates an embodiment of a posting rules table for implementing posting types or classes for posting itemline type of a sales invoice document type.

FIG. 4 illustrates an embodiment of posting lines generated by the posting procedures for income and COGS posting types as set forth in the posting rules table of FIG. 3.

FIGS. 5-6 illustrate a posting table for income and COGS postings generated by a posting engine based upon input posting lines of FIG. 4.

FIG. 7 illustrates an embodiment for generating tax postings based upon tax groups for the document and document line type.

FIGS. 8-10 illustrate an embodiment for generating a settlement table to settle a payment transaction relative to related accounts or documents.

### DETAILED DESCRIPTION OF ILLUSTRATIVE EMBODIMENTS

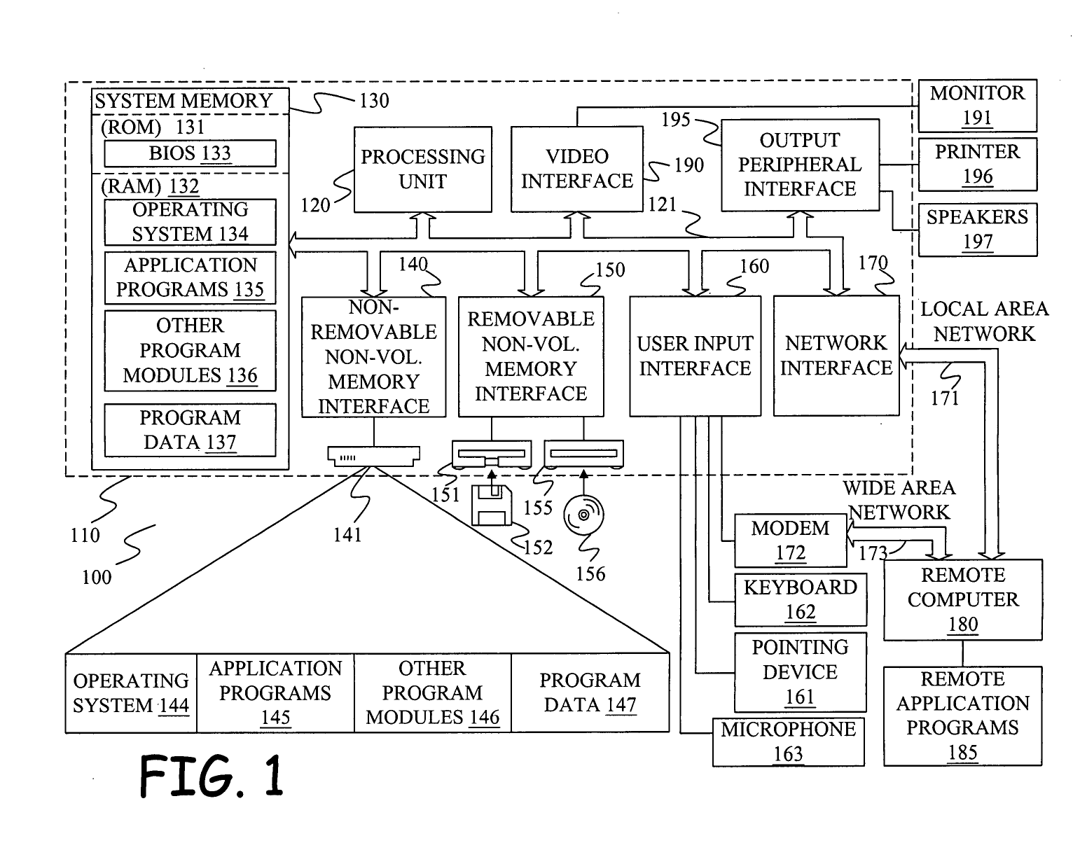

The present invention relates to a system for posting or populating a transaction, such as a financial transaction to an account or document. The invention can be implemented in a computing environment as illustrated in FIG. 1. Prior to describing the invention, an embodiment of a computing environment 100 in which the invention can be implemented will be described with respect to FIG. 1.

The computing system environment 100 shown in FIG. 1 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement aspects of the present invention as instructions stored on computer readable media based on the description and figures provided herein.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during startup, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

The present invention provides a data driven approach to encapsulate the posting rules for documents representing a real word business transaction. Embodiments of the posting process described in the invention or application transform inputs from a document, document lines to output that creates entries for a general ledger in an accounting application. The transformation process embodies several stages analogous to a pipeline model.

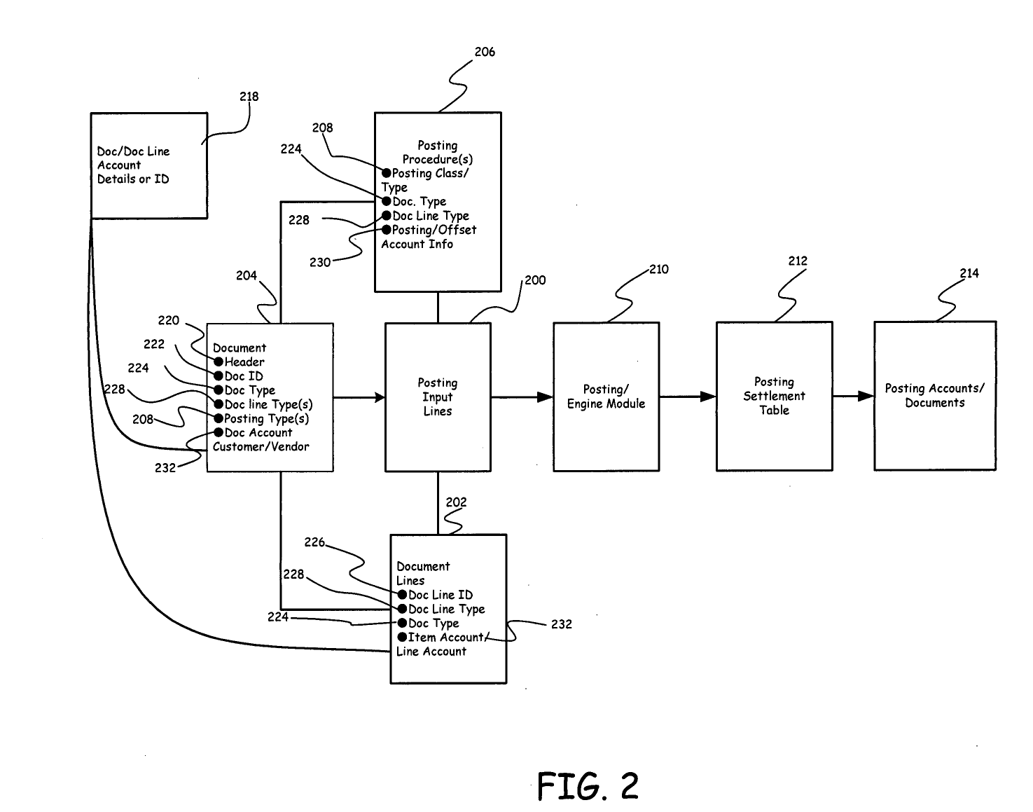

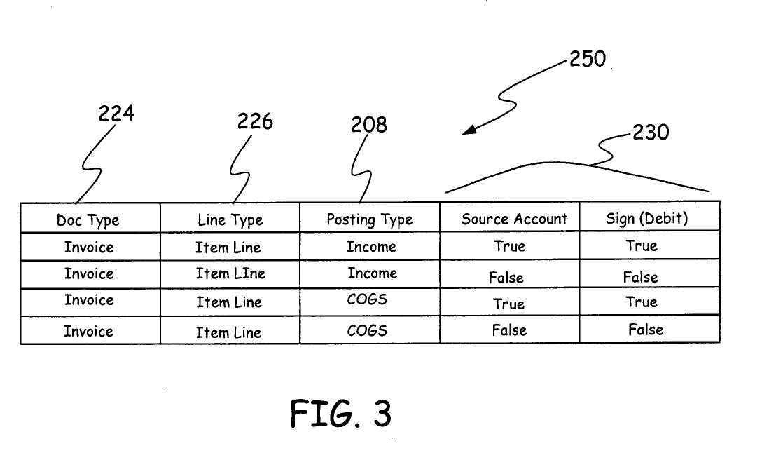

FIG. 2 illustrates application of the present invention to generate posting lines 200 for document lines 202 in a document 204 using posting procedures 206 for a particular posting class or type 208.

As shown in FIG. 2 (needs arrows showing the flow), a posting engine 210 receives the posting lines 200 and generates a posting table as illustrated by block 212 to post transactions from the document or document lines to a financial account or accounts as illustrated by block 214. In one embodiment, the transaction is posted to financial accounts 214 based upon document and document line account details or identification 218 retrieved from the document.

In the embodiment shown, the document 204 includes a header 220, a document identification 222 and a document type attribute 224, such as invoice. The header 220 of the document includes, for example, customer or vendor information. The document lines 202 include a document line identification 226 and a document line type attribute 228, such as invoice item.

The document 204 is attributed to a posting type 208 and the posting type 208 is attributed to the document type 224 and document line type 228 to generate a transaction posting. The document is also attributed to the document line type 228 and the document line type 228 is attributed to the document type 224 to associate the document line with the document. For example, for a sales invoice document type, the document line types=(itemline type, summary line type).

The posting type 208 is attributed with the document type 224 and document line type 228 to implement the posting for the associated document type and document line type. The posting procedure 206 retrieves posting details from the document and document lines to generate the posting lines 200 as previously described based upon the document type 224 and document line type 228.

In a particular illustrated embodiment, the document attribute includes a posting notation [IsTranactional=True] to indicate that the document supports posting. This or other attributes can be automatically selected or generated based upon the document type created in the accounting or management application.

The posting procedures post transactions to a particular posting account 214 based upon the posting class or type, document type and/or document line type. The posting account 214 can include a source account and offset account. In particular, the posting procedure includes posting account information 230 to post the transaction based upon the document type and/or document line type 228.

For different posting types, posting account details are retrieved from the document through account attributes 232 associated with the document or document line. For example, the posting type may generate a posting to a customer or financial account, the identification of which is retrieved from the document. Depending upon the posting type, the posting procedure can post to an offset account, for example, for a sales invoice document, a CustomerAccount is attributed with [IsOffsetAccount=True] to post to an offset account for double entry accounting.

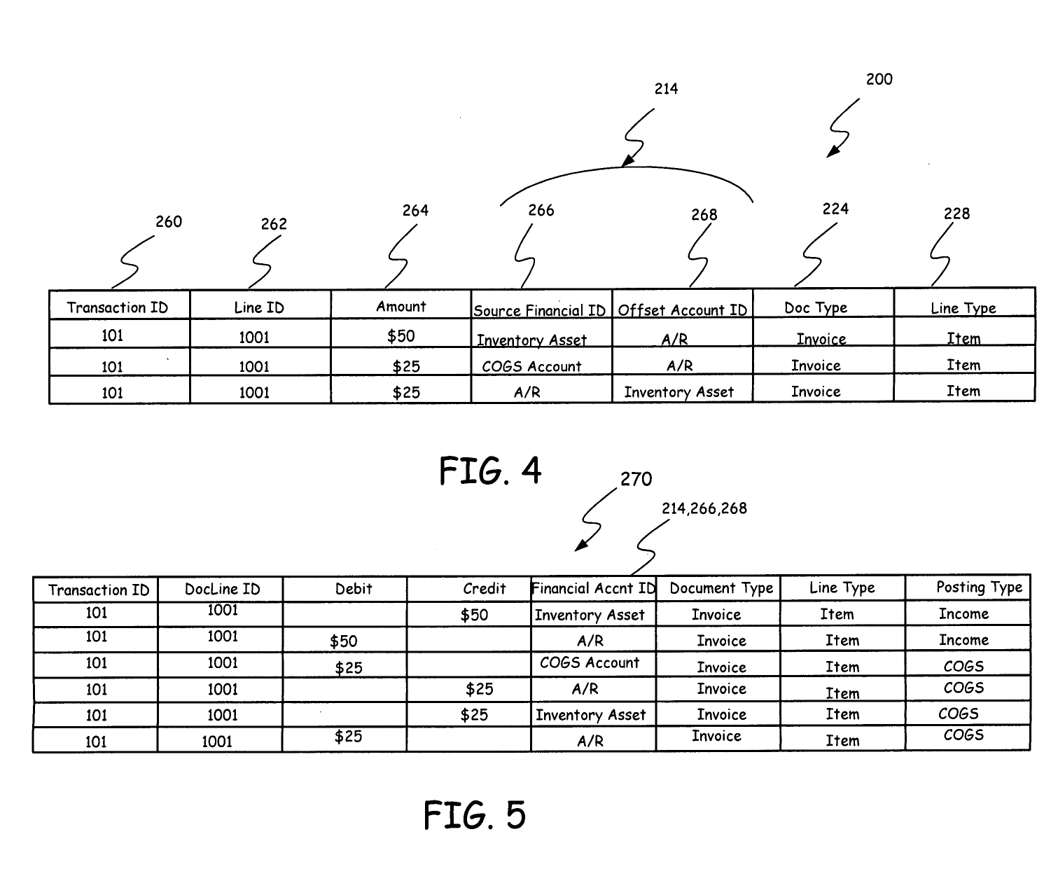

FIGS. 4-6 illustrate an embodiment for implementing the posting procedures for a transaction document. As illustrated in FIG. 4 the document type 224, document line type 228 and posting type 208 are associated in a posting rules table 250. In the embodiment shown, the rules table 250 attributes the posting class or types for an invoice document type and item document line type. The rules table 250 also provides posting account and offset account information 230 based upon the posting type 208, document type 224 and document line type 228.

In the embodiment shown, the rules table 250 includes an association for an item line of a sales invoice document to income and COGS posting types. The application uses this association to call or invoke the income and COGS posting procedures to post the item line transaction of the invoice document. This call or posting can be automatically invoked for example upon completion of the document when the document is saved or as directed by a user through an application interface.

In an illustrated embodiment, the application uses posting classes, such as FIFO (First-In-First-Out) Posting Class, SubTotal Posting Class, Deposit Posting Class, Payment Posting Class, Journal Posting Class and Tax Posting Class to invoke different posting types. Posting classes stamp every posting with a posting type specific for that posting class. A posting class can implement multiple posting types, but multiple posting classes cannot implement the same posting type.

As previously described, the posting procedures generate posting lines 200 as illustrated in FIG. 4 from the information or transaction in the document or document lines to post the transactions to accounts associated with the posting type 208, document type 224 or document line type 228. In particular, for a particular document type, such as a sales invoice, and document line type, such as item line, the posting procedures generate posting lines including transaction ID 260, line ID 262, amount 264, and sourceFinanical Account 266 and offset account 268 based upon details retrieved from the document 204 and document lines 202 using the document type 224 and document line type 228.

For example, the posting procedures retrieve the transaction ID 260 from the document identification 222, the Line ID 262 from the document line identification 226 and the amount from the document line 202. The transaction or amount is posted to source and offset account defined in the posting procedure for the document type. In one embodiment, specific customer or item account numbers or details for the posting account 266, 268 are retrieved by the posting procedure from the document.

For example, for an invoice document, the income posting procedure retrieves customer and item accounts and generates an income posting to inventory asset and an offset to A/R and for COGS posting type, the posting procedure retrieves a customer account and item account and generates a posting to COGS with offset to A/R and to A/R and offset posting to an inventory asset account for the customer and item account details retrieved from the document.

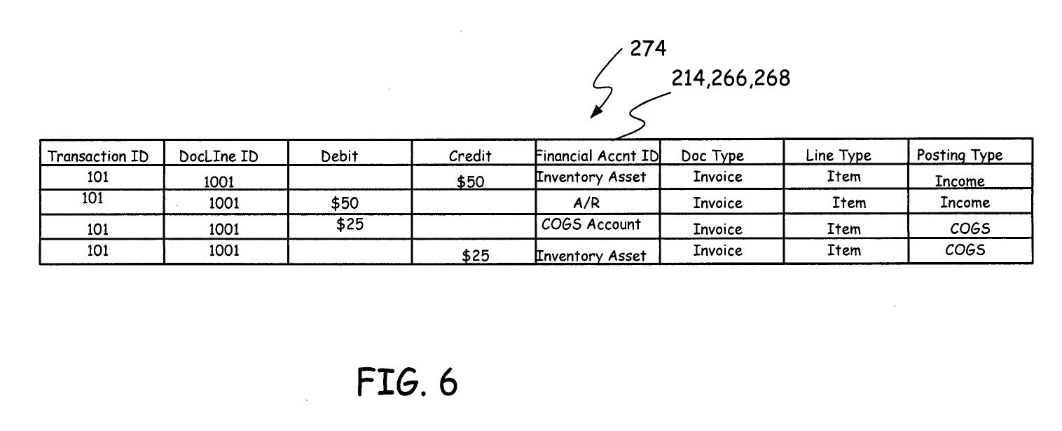

The posting engine or module 210 previously shown in FIG. 2 generates a posting table 270 as illustrated in FIG. 5 from the posting lines 200 generated for the posting class or posting types associated with the document type and document line type. The output posting lines include debit and credits to the designated financial accounts 226, 268 of the posting lines 200. Thereafter, as illustrated in FIG. 6, the posting table 270 is optimized to generate posting table 274. In the illustrated embodiment, the credit and offset debit posting to A/R is eliminated from the posting table 274.

FIGS. 4-6 illustrate application of the present invention with respect to income and COGS postings for a sales document, however the application can implement or include many different postings for different financial or application documents and lines such as expense posting, bank transfers, inventory adjustment, journal entry, vendorbill posting, finance charge, vendor expense, discount, cash back, sales quote, sales order, sales invoice, time slips, refunds, tax vendor payment, employeebill, payment postings, and tax postings. The following charts describe different posting types in reference to document types and document line types which can be implemented, however, application is not limited to the specific posting types described.

Income Posting type

| | Document line | |
|---|---|---|
| Document types | types | Comment |
| Sales invoice | Contract item | Posting procedure retrieves |
| document | line | financial account for |
| | | customer and income account |
| | | and creates credit posting |
| | | to income and debit |
| | | posting for A/R |
| Cash sales | Contract item | Creates debit to income |
| invoice | line type | and credit to A/R |
| Sales credit memo | Contract item | |
| CustomerCredit | line type | |
| Cash Invoice | Contract item | |
| Document | line type | |
| Cashcustomer | Contract item | |
| Credit memo | line type | |

COGS Posting Type

| | Document line | |
|---|---|---|
| Document type | type | Comment |
| Sales Invoice | Contract Item | Posting procedure retrieves |
| Document | Line type | customer account for COGS |
| | | posting and account for |
| | | item and generates credit |
| | | income posting and debit A/R |
| Customer Credit | Contract item | Creates debit income posting |
| memo | line type | and credit A/R |
| Vendor Bill | Contract item | |
| document | line type | |
| Cash Invoice | Contract item | |
| Document | line type | |
| Vendor Credit | Contract item | |
| memo | line type | |
| Item receipt | Contract expense | |
| | line type | |
| Cash Vendor Bill | Contractitem | |
| | line type | |
| Cash Customer | Contract item | |
| Credit Memo | line type | |
| Cash Vendor | Contract item | |
| Credit memo | line type | |
| Cash Employee | Contract item | |
| Bill | line type | |

Expense Posting

| Document Type | Document Line type | Comment |
|---|---|---|
| Sales Invoice Document | Contract Expense line type | |
| Customer Credit Memo | Contract Expense Line Type | |
| Vendor Bill Document | Contract Expense Line | |
| Cash Invoice Document | Contract Expense line | |
| Vendor Credit Memo | Contract Tax line type | |
| Item receipt | Contract expense line type | |
| Cash vendor bill | Contract expense line type | |
| Cash customer credit memo | Contract expense line type | |
| Cash vendor credit memo | Contract expense line type | |
| Cash employee Bill | Contract expense line type | |

Adjustment Posting

| Document type | Document Line Type | Comment |
|---|---|---|
| Inventory Adjustment | Inventory Adjustment line | |
| Journal Entry | Journal Line | No offset account |

Finance Charge Posting

| Document type | Document Line type | Comment |
|---|---|---|
| Sales Invoice Document | Contract Finance | |
| | Charge Line Type | |
| Customer Credit Memo | Contract Finance | |
| | Charge Line Type | |
| Cash Invoice Document | Contract Finance | |
| | Charge Line Type | |
| Cash Customer Credit memo | Contract Finance | |
| | Charge Line type | |
| Finance Charge Sales invoice | Contract financial | |
| | charge line type | |

Vendor Expense Posting

| Document Type | Document Line Type | Comment |
|---|---|---|
| Vendor Bill Document | Contract item line type | |
| Vendor Credit memo | Contract item line type | |
| Item receipt | Contract item line type | |
| Cash vendor bill | Contract item line type | |
| Cash Vendor Credit memo | Contract item line type | |
| Cash Employee Bill | Contract item line type | |

Asset Posting

| Document type | Document line type | Comment |
|---|---|---|
| Vendor bill document | Contract item line type | |
| Vendor Credit Memo | Contract item line type | |
| Item receipt | Contract item line type | |
| Cash vendor bill | Contract item line type | |
| Cash vendor credit memo | Contract item line type | |
| Cash employee Bill | Contract item line type | |

Writeoff Postings

| Document type | Document line Type | Comment |
|---|---|---|
| Customer Payment Document | Unused payment line | |

Discount Posting

| Document Type | Document Line Type | Comment |
|---|---|---|
| Vendor Payment | Unused payment line | |
| Customer Payment | Unused payment line | |

Deposit Posting

| Document type | Document line type |
|---|---|
| Deposit | Deposit line |

Cash Back Posting

| | |
|---|---|
| Document Type | Document line type |

Payment posting

| Document type | Document line type | Comment |
|---|---|---|
| Cash invoice document | Unused payment line | |
| Vendor payment | Unused payment line | |
| Cash vendor bill | Unused payment line | |
| Cash customer credit memo | Unused payment line | |
| Cash vendor credit memo | Unused payment line | |
| Cash employee bill | Unused payment line | |

Tax - Line Tax postings

| Document type | Document line type | Comment |
|---|---|---|
| Sales invoice | Contract tax | calculates tax lines |
| document | line type | based upon table |
| | | code on the customer |
| | | or vendor account |
| | | and item tax group |
| Customer credit memo | Contract tax | |
| | line type | |
| Vendor bill | Contract tax | |
| | line type | |
| Cash invoice document | Contract tax | |
| | line type | |
| Journal entry | Journal tax line | |
| Vendor credit memo | Contract tax | |
| | line type | |
| Item receipt | Contract tax | |
| | line type | |
| Cash vendor bill | Contract tax | |
| | line type | |
| Cash customer credit memo | Tax line type | |
| Cash vendor credit memo | Contract tax | |
| | line type | |
| Cash employee bill | Contract tax | |
| | line type | |

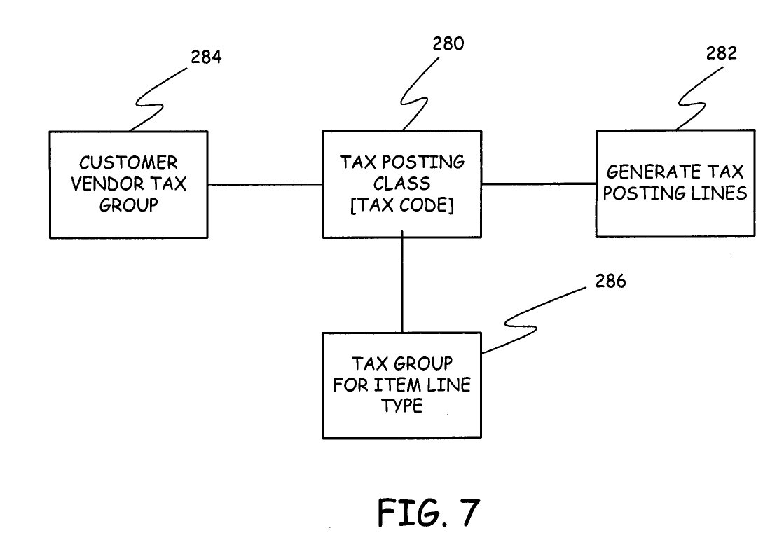

In one embodiment, the present invention implements tax postings for sales or purchase documents using a tax posting class or type which implements different tax postings, such as line tax posting, sales tax posting, value added tax (VAT) posting. As illustrated in FIG. 7, the application includes a tax engine or posting type 280 to generate tax posting lines 282. The tax engine 280 is configured to generate only line input and does not generate offset postings. In order to create the tax lines, the tax engine or tax posting type procedure uses the following parameters: ItemID, CustomerID (or VendorID), Quantity, TotalAmount, IsDebit (to denote whether it is a sale/purchase or return); and Financial Date.

The tax engine 280 will return a number of tax lines containing the taxvendorID, Tax amount based upon applicable taxes depending upon the source or origin of the transaction, such as sales tax or value added tax (VAT). In particular, the tax posting lines 282 are generated based on tax codes common to the particular sales or purchase tax group 284, e.g. for a customer or vendor and item group or identification 286 as illustrated in FIG. 7 for an item or document line type.

Some transaction postings such as payments include a settlement against other transactions. For instance, in the case of a customer or vendor payment against several invoices, the paid amount against each invoice needs to be settled against the corresponding invoice or document.

Settlement includes the following attributes:
SourceTransactionID—TransactionID associated with the document initiating the settlement such as a payment or credit document
DestinationTransactionID—TransactionID associated with the document that is being settled—such as an invoice
Settlement amount

Hence, in the case of a payment document settled against an invoice, the document lines in the document will contain the TransactionIDs associated with each invoice (or settlement document) against which the payment is to be settled.

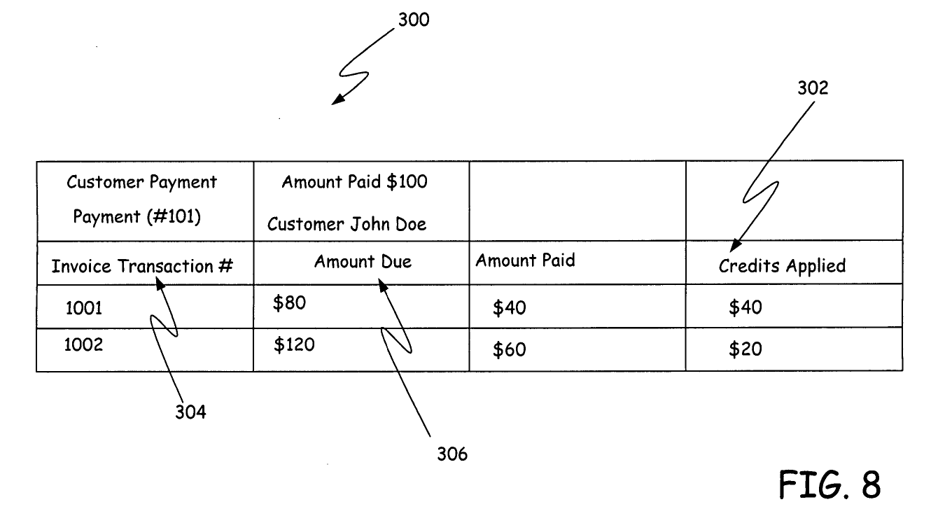

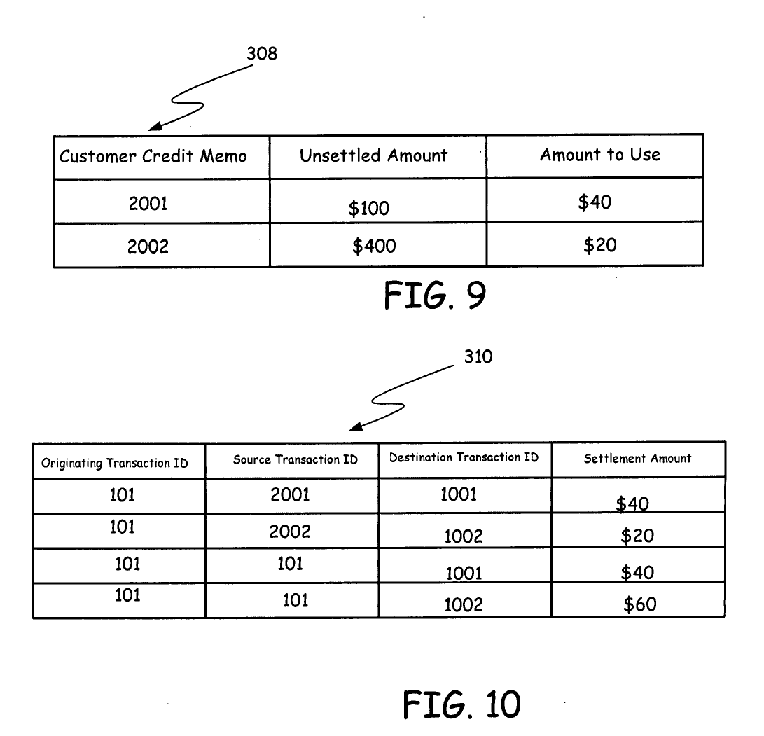

FIGS. 8-10 progressively illustrate implementation of settlement procedures to settle a payment #101 against invoice document nos. 1001 and 1002 identified in the document lines of the payment document. As shown in FIG. 8, the procedure generates settlement lines 300 for the payment relative to invoice # 304 and invoiced amount due 306 retrieved from the invoice documents. In addition as shown in FIG. 8, the payment is settled with respect to applied credits 302 from credit memo documents 308 as shown in FIG. 9 attributed to the payment document. As shown in FIG. 10, a settlement table 310 is generated based upon the settlement lines 300 and association to the credit memo documents 308.

The following table identifies examples of posting types and posting accounts for different financial documents and accounting applications, although application is not limited to the specific examples shown.

| Process | OutputLineType | FinancialAccount From |
|---|---|---|
| Post | Income | SalesPurchaseItemLine.ItemID.SalesFinancialAccountID |
| Invoice | COGS | SalesPurchaseItemLine.ItemID.COGSAccountID |
| | Expense | SalesPurchaseExpenseLine.FinancialAccountID |
| | LineTax | TaxCode.TaxVendor.SalesTaxFinancialAccountID |
| | LineTax | SalesPurchaseTaxLine.TaxCode.TaxVendor.SalesTaxFinancialAccountID |
| | DocTaxDiff | TaxCode.TaxVendor.SalesTaxFinancialAccountID |
| | Asset | SalesPurchaseItemLine.Item.AssetAccountID |
| | OFFSET | Contract.CustomerAccount.ARAccountID |
| Post Cash | Income | SalesPurchaseItemLine.ItemID.SalesFinancialAccountID |
| Invoice | COGS | SalesPurchaseItemLine.ItemID.COGSAccountID |
| | Expense | SalesPurchaseExpenseLine.FinancialAccountID |
| | LineTax | TaxCode.TaxVendor.SalesTaxFinancialAccountID |
| | LineTax | SalesPurchaseTaxLine.TaxCode.TaxVendor.SalesTaxFinancialAccountID |
| | DocTaxDiff | TaxCode.TaxVendor.SalesTaxFinancialAccountID |
| | Asset | SalesPurchaseItemLine.ItemID.AssetAccountID |
| | Payment | CashInvoice.FinancialAccountID |
| | Discount | SystemAccount.CashDiscount Given |
| | OFFSET | Contract.CustomerAccount.ARAccountID |
| Post | Income | SalesPurchaseItemLine.ItemID.SalesFinancialAccountID |
| Customer | COGS | SalesPurchaseItemLine.ItemID.COGSAccountID |
| Credit | Expense | SalesPurchaseExpenseLine.FinancialAccountID |
| memo | LineTax | TaxCode.TaxVendor.SalesTaxFinancialAccountID |
| | LineTax | SalesPurchaseTaxLine.TaxCode.TaxVendor.SalesTaxFinancialAccountID |
| | DocTaxDiff | TaxCode.TaxVendor.SalesTaxFinancialAccountID |
| | Asset | SalesPurchaseItemLine.ItemID.AssetAccountID |
| | OFFSET | SalesPurchaseContract.CustomerVendorID.ARAccountID |
| Post | Payment | CustomerVendorPaymentFinancialAccountID |
| Customer | | Defined at the CustomerPayment.FinancialAccountID |
| Payment | Discount | SystemAccount.CashDiscount Given |
| | OFFSET | CustomerVendorPayment.CustomerVendorAccountID.ARAccountID |
| Post Item | Asset | SalesPurchaseItemLine.ItemID.AssetAccountID |
| Receipt | LineTax | TaxCode.TaxVendor.PurchaseTaxFinancialAccountID |
| | LineTax | SalesPurchaseTaxLine.TaxCode.TaxVendor.PurchaseTaxFinancialAccountID |
| | OFFSET | SalesPurchaseContract.CustomerVendorAccountID.APAccountIDContract.VendorAccount.APAccountID |
| Post Bill | Asset | SalesPurchaseItemLine.ItemID.AssetAccountID |
| | LineTax | TaxCode.TaxVendor.PurchaseTax' FinancialAccountID |
| | LineTax | SalesPurchaseTaxLine.TaxCode.TaxVendor.PurchaseTaxFinancialAccountID |
| | OFFSET | SalesPurchaseContract.CustomerVendorAccountID.APAccountIDContract.VendorAccount.APAccountID |
| Post Cash | Asset | SalesPurchaseItemLine.ItemID.AssetAccountID |
| Bill | LineTax | TaxCode.TaxVendor.PurchaseTaxFinancialAccountID |
| | LineTax | SalesPurchaseTaxLine.TaxCode.TaxVendor.PurchaseTaxFinancialAccountID |
| | Payment | CashBill.FinancialAccountID |
| | Discount | SystemAccount.CashDiscount Taken |
| | OFFSET | SalesPurchaseContract.CustomerVendorAccountID.APAccountIDContract.VendorAccount.APAccountID |
| Vendor | Asset | SalesPurchaseItemLine.ItemID.AssetAccountID |
| Credit | LineTax | TaxCode.TaxVendor.PurchaseTaxFinancialAccountID |
| Memo | LineTax | SalesPurchaseTaxLine.TaxCode.TaxVendor.PurchaseTaxFinancialAccountID |
| | OFFSET | SalesPurchaseContract.CustomerVendorAccountID.APAccountID |
| Cash | Payment | CustomerVendorPayment.FinancialAccountID |
| Customer | Income | CheckItemLine.ItemID.SalesFinancialAccountID |
| credit | COGS | CheckItemLine.ItemID.COGSAccountID |
| memo | LineTax | TaxCode.TaxVendor.SalesTaxFinancialAccountID |
| | LineTax | CheckItemLine.TaxCode.TaxVendor.SalesTaxFinancialAccountID |
| | DocTaxDiff | TaxCode.TaxVendor.SalesTaxFinancialAccountID |
| | Asset | CheckItemLine.ItemID.AssetAccountID |
| | Expense | CheckExpenseLine.FinancialAccountID |
| | LineTax | CheckTaxLine.TaxCode.TaxVendor.SalesTaxFinancialAccountID |
| | OFFSET | CustomerVendorPayment.CustomerVendorAccountID.ARAccountID |
| CashVendor | Payment | CustomerVendorPayment.FinancialAccountID |
| CreditMemo | Expense | CheckExpenseLine.FinancialAccountID |
| | Asset | CheckItemLine.ItemID.AssetAccountID |
| | LineTax | CheckTaxLine.TaxCode.TaxVendor.SalesTaxFinancialAccountID |
| | OFFSET | CustomerVendorPayment.CustomerVendorAccountID.APAccountID |
| Post Check | Payment | Employee.FinancialAccountID |
| to | Expense | CheckExpenseLine.FinancialAccountID |
| Employee | Asset | CheckItemLine.ItemID.AssetAccountID |
| | LineTax | CheckTaxLine.TaxCode.TaxVendor.SalesTaxFinancialAccountID |
| | OFFSET | CustomerVendorPayment.FinancialAccountID |
| Post | Sign of amount depends on user input | |
| Journal | Adjustment | JournalEntryLine.AccountID (Finance Account Types) |
| Entry | Adjustment | JournalEntryLine.AccountID.ARAccountID (Customer Account Type) |
| | Adjustment | JournalEntryLine.AccountID.APAccountID (Vendor Account Type) |
| | Adjustment | JournalEntryLine.AccountID.SalesTaxFinanceAccount (Item Account Type) |
| | Adjustment | JournalEntryLine.AccountID.SalesTaxFinanceAccount (TaxVendor Account Type combined |
| | | with SalesTaxCode) |
| | Adjustment | JournalEntryLine.AccountID.PurchaseTaxFinanceAccount (TaxVendor Account Type combined |
| | | with PurchaseTaxCode) |
| | Adjustment | JournalEntryLine.AccountID.Asset AccountId (InventoryItemAccount Type) |
| | Adjustment | JournalEntryLine.AccountID.SalesFinancialAccountID (Other Item Account Types) |
| | OFFSET | NO OFFSET ACCOUNT |
| Post | Sign of amount depends on user input | |
| Inventory | Adjustment | InventoryAdjustmentLine.ItemID.AssetAccountIdInventoryItemAccount Type) |
| Adjustment | OFFSET | InventoryAdjustment.FinancialAccountID |
| Post | Payment | CustomerVendorPayment.FinancialAccountID |
| Vendor | Discount | SystemAccount.CashDiscount Received |
| Payment | OFFSET | BankAccount |

The following table illustrates example posting types for various document types and document line types, however, application is not limited to the specific examples included.

| Process | LineType | Output PostingTypes |
|---|---|---|
| Post | Item | Income, COGS, LineTax; in one |
| Invoice | | embodiment DocTaxDiff in EU; |
| | | Discount |
| | Expense | Expense |
| | Summary | No posting required |
| | Note | No posting required |
| | FlatTax | LineTax |
| | Offset for postings is A/R | |
| Post Cash | Item | Income, COGS, Payment, LineTax; |
| Invoice | | in one embodiment DocTaxDiff in |
| | | EU, Discount |
| | Expense | Expense |
| | Summary | No posting required |
| | Note | No posting required |
| | FlatTax | LineTax |
| | Item | Income, COGS, LineTax; DocTaxDiff |
| | | in EU |
| | Offset for postings is A/R | |
| Post | Item | Income, COGS, Payment, LineTax; |
| Customer | | (DocTaxDiff in EU), Discount |
| Credit | Expense | Expense |
| memo | Summary | No posting required |
| | Note | No posting required |
| | FlatTax | LineTax |
| Post | Payment | Payment, Settlement |
| Customer | | (Payment/Discount/CreditMemo/ |
| Payment | | Payments vs Invoices) |
| | OFFSET | BankAccount |
| Post Item | Item | LineTax |
| Receipt | OFFSET | A/P |
| Post Bill | Item | LineTax |
| | Expense | Expense |
| | OFFSET | A/P |
| Post Check | Item | Same as a customer credit memo |
| to | Expense | Expense |
| customer | Asset | CheckItemLine.ItemID.Asset |
| | | AccountID |
| | LineTax | CheckTaxLine.TaxCode.TaxVendor. |
| | | SalesTaxFinancialAccountID |
| | OFFSET | CustomerVendorPayment.Customer |
| | | VendorAccountID.ARAccountID |
| Post | Payment | Payment, Settlement |
| Vendor | | (Payment/Discount/CreditMemo/ |
| Payment | | Payments vs Bills) |
| (pay | OFFSET | CustomerVendorPayment.Customer |
| bills) | | VendorAccountID.ARAccountID |
| Post Check | Item | Same as vendor bill (offset is a |
| to Vendor | | bank account) |
| | OFFSET | CustomerVendorPayment.Customer |
| | | VendorAccountID.APAccountID |
| Post Check | Payment | CustomerVendorPayment.Financial |
| to | | AccountID |
| Employee | Expense | CheckExpenseLine.Financial |
| | | AccountID |
| | Item | CheckItemLine.ItemID.Asset |
| | | AccountID |
| Post | Adjust- | Adjustment |
| Journal | Ment | |
| Entry | OFFSET | NO OFFSET ACCOUNT |
| Post | Adjust- | InventoryAdjustmentLine.ItemID. |
| Inventory | Ment | AssetAccountId |
| Adjustment | | InventoryItemAccount Type) |
| | OFFSET | InventoryAdjustment.Financial |
| | | AccountID |

Although the present invention has been described with reference to particular embodiments, workers skilled in the art will recognize that changes may be made in form and detail without departing from the spirit and scope of the invention. In particular, embodiments of the present invention have been described with respect to financial transaction postings. Application of the present invention is not limited to financial transaction postings and can be used to populate other data management applications such as work load management system.

What is claimed is:

1. An application program on a computer readable medium comprising:
a computer generatable document including a document type attribute associated with a posting class or posting type; and
a posting procedure for the posting class or posting type for posting a transaction from the document.

2. The application program of claim 1 wherein the document includes a document line and a document line type attribute associated with the posting class or posting type.

3. The application program of claim 1 wherein the posting procedure generates posting lines to post the transaction from the document to a posting account.

4. The application program of claim 3 including a posting engine configured to generate a posting table based upon the posting lines generated by the posting procedure for the posting type attributed with the document type.

5. The application program of claim 1 including a plurality of posting types associated with the document type.

6. The application program of claim 2 including a plurality of posting types associated with the document line type.

7. The application program of claim 1 wherein the transaction is posted to a posting account type determined based upon the posting type and document type.

8. The application program of claim 1 wherein the posting procedure for the posting class or posting type is automatically invoked when the document is saved.

9. The application program of claim 1 wherein the posting procedure generates an offset posting attribute based upon the posting class or posting type and the document type.

10. The application program of claim 2 wherein the document type is attributed with the document line type and the document line is attributed with the document type.

11. The application program of claim 1 wherein the posting procedure for the posting class or the posting type is configured to implement postings for a plurality of document types.

12. The application program of claim 2 and comprising tax procedures to generate posting lines for taxed transactions from the document or the document lines based upon tax posting types or class attributed to a tax group for the document type and the document line type.

13. The application program of claim 1 wherein the document is a payment document and the application generates settlement lines or a settlement table to settle a payment to settlement documents attributed to the payment document.

14. A method of posting transactions comprising the steps of:
attributing a document type of a document with a posting type or posting class; and
invoking a posting procedure for the posting type or the posting class attributed to the document type of the document.

15. The method of claim 14 and further comprising the steps of:
attributing a document line of the document with a document line type; and
attributing the document line type with the posting class or posting type to generate the posting based upon association of the posting type with the document type and the document line type.

16. The method of claim 15 and further comprising the step of:
attributing the document line type to the document type.

17. The method of claim 14 wherein the invoked posting procedure generates posting lines to post a transaction to a posting account associated with the document type and posting type.

18. The method of claim 14 wherein the document is a payment document and further comprising the step of:
invoking a settlement procedure to generate a settlement line or table for a payment against a settlement document associated with the payment document.

19. A method of populating a transaction from a document comprising the steps of:
attributing the document with a population type; and
invoking a procedure for the attributed population type to populate the transaction from the document.

20. The method of claim 19 and further comprising the step of:
attributing a document type of the document and a document line type of a document line of the document to the population type to populate the transaction.
